(19) United States
(12) Patent Application Publication
(10) Pub. No.: US 2008/0217904 A1
(43) Pub. Date: Sep. 11, 2008

(54) CHILDREN'S BOOK MOBILE

(76) Inventor: Lorena Romero Wright, Woods Cross, UT (US)

Correspondence Address: RANDALL B. BATEMAN;BATEMAN IP LAW GROUP, 8 EAST BROADWAY, SUITE 550, PO BOX 1319, SALT LAKE CITY, UT, 84110, US

(21) Appl. No.: 12/044,777

(22) Filed: Mar. 7, 2008

Related U.S. Application Data
(60) Provisional application No. 60/893,676, filed on Mar. 8, 2007.

(51) Int. Cl. A63H 33/38; B42D 17/00

(52) U.S. Cl. 281/43; 446/227

(57) ABSTRACT

A children's mobile presents a book to a child. The mobile holds the book open and turns the pages at a predetermined time, and may also present an audio recording of the book to the child along with the book so as to ‘read’ the book to the child.

### RELATED APPLICATIONS

The present application claims the benefit of U.S. Provisional Application Ser. No. 60/893,676, filed Mar. 8, 2007, which is expressly incorporated herein by reference.

### BACKGROUND OF THE INVENTION

1. The Field of the Invention

The present invention relates to a children's mobile. More specifically, the present invention relates to a children's mobile which presents a book to the child.

2. State of the Art

Mobiles and similar devices are frequently used to entertain children while the child is seated, laying in a crib, etc. The mobiles often have small animals or other objects hanging from a support. Some mobiles move the animals around to keep the child's attention for a longer period of time.

While existing mobiles may be effective in entertaining a child for a period of time, the child will usually tire of the mobile and look for other entertainment. If other entertainment is not readily available, the child may cry or grow restless.

An additional problem with many mobiles is that they have little if any educational value. Any educational benefit is quickly achieved and the child looks for other sources of visual stimulation.

It would be desirable to have a device which is able to entertain a child over a prolonged period of time. Additionally, it would be desirable to have a device which may aid in educating a child. Thus, it would be desirable to have a children's mobile or similar device which could present a book to the child. The book may be a story or picture book or a photo album. It is further desirable to have a children's mobile which plays an audio recording of the book to a child, such as reading the book or describing the pictures in the book to the child. In such a manner a child may be entertained and even educated in a situation in which an adult may not be present.

### SUMMARY OF THE INVENTION

It is an object of the present invention to provide a children's mobile which displays books.

According to one aspect of the invention, a mobile is presented which displays a book to a child. The mobile is typically placed in an area such as above or adjacent the child in a crib, bed, seat, etc. The mobile may display various different types of books, such as conventional children's books, photo albums, etc. The books may simply tell a story, may provide educational materials such as shapes or animals along with their names, or may be used to teach the child or introduce relatives to the child.

The mobile turns the pages of the book to display the whole book to the child, and not just a single picture. Thus, neither the child nor an adult need be able to turn the pages of the book as it is being read. This allows the child to keep visually stimulated when an adult is not present (such as a child who is having a hard time falling asleep after waking in the middle of the night).

In accordance with one aspect of the invention, the mobile can be provided with a transparent cover to prevent the child from contacting the pages of the book. The cover may be mounted in a turn-lock configuration so that an adult may readily remove the cover to change the book, etc.

According to another aspect of the invention, the mobile may play an audio track. The mobile may contain a recording of the book such that the mobile “reads” the book to the child. The mobile may include places to insert recording media which corresponds to the book, or may also include provisions to allow a person to record a customized soundtrack which is then played for the child. Thus, a parent's voice may be used to read the book to the child or to talk about relatives shown in a picture album, etc. The mobile may also have decorative lights, etc. to further entertain the child.

These and other aspects of the present invention are realized in a children's book mobile as shown and described in the following figures and related description. It will be appreciated that not all embodiments of the invention will contain each aspect discussed above and the appended claims should not be viewed as limited by the discussion of various aspects of the several embodiments of the invention.

### BRIEF DESCRIPTION OF THE DRAWINGS

Various embodiments of the present invention are shown and described in reference to the numbered drawings wherein:

FIG. 1 shows a schematic diagram of the mobile of the present invention;

FIG. 2 shows another top schematic view of the mobile of the present invention;

FIG. 3 shows a front view of the mobile of the present invention;

FIG. 4 shows a schematic view of a control panel of the present invention;

FIG. 5 shows a perspective view of a book or photo album as may be used with the present invention; and

FIG. 6 shows a rear view of a book having a circuit disposed thereon for storing an audio file associated with the book.

It will be appreciated that the drawings are illustrative and not limiting of the scope of the invention which is defined by the appended claims. The embodiments shown accomplish various aspects and objects of the invention. It is appreciated that it is not possible to clearly show each element and aspect of the invention in a single figure, and as such, multiple figures are presented to separately illustrate the various details of the invention in greater clarity. Similarly, not every embodiment need accomplish all advantages of the present invention.

### DETAILED DESCRIPTION

The invention and accompanying drawings will now be discussed in reference to the numerals provided therein so as to enable one skilled in the art to practice the present invention. The drawings and descriptions are exemplary of various aspects of the invention and are not intended to narrow the scope of the appended claims.

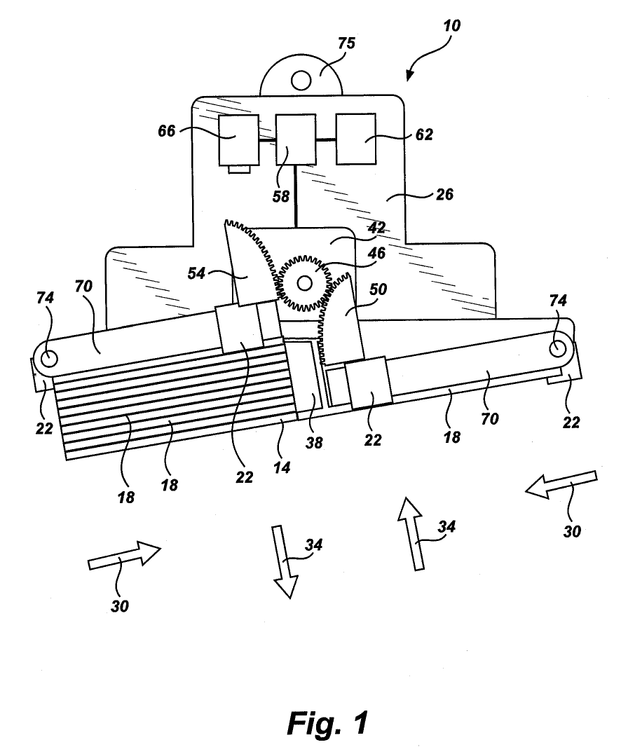

Turning now to FIG. 1, a top schematic view of a mobile of the present invention is shown. The term mobile is used because the device may be hung so as to be viewed by an infant in a bed. However, it will be appreciated that the device can be attached to various structures in a manner such that the mobile can be readily displayed to a child while not in bed. For example, the device can be attached to the side of a crib, on a frame adjacent a booster seat or even to the back of a seat in an automobile.

The mobile 10 is primarily used to hold a book 14 in an open position so as to selectively display the pages 18 of the book to a child. The mobile 10 works best with books 14 that have thick cardboard pages 18, such as conventional infant books as this allows the book to be held open even when the book is facing downward. Specialized books 14 may be provided as is desired. For example, books 14 with plastic pages 18 may be provided for use in hospitals or the like as these books may be sterilized. Clamps 22, or other retention devices are used to hold the book 14 to the body 26 of the mobile 10. It has been discovered that most of the thick paged infant books will stay open if a small inward pressure is applied to the front and back pages of the book in the directions indicated by arrows 30. Thus, the clamps 22 compress the book somewhat in the direction 30 and aid in keeping the book open.

Moving the two sides of the book 14 adjacent the spine 38 of the book in the directions shown by arrows 34 will turn the pages 18 of the book, while keeping the pages open so as to display the pages of the book to a child. A motor 42, such as a stepper motor, with an output gear 46 may be selectively rotated to move gear members 50, 54 in the directions shown by arrows 34 to turn the pages 18 of the book 14. The motor 42 is typically controlled by signals from a computer controller 58 which is programmed to move the motor at the desired time to turn the pages, and to move the motor the desired amount to turn a single page at a time. The mobile 10 may include memory 62 which contains the operating firmware to operate the mobile, and may also contain a battery 66 to provide power. A power jack may also be provided.

The book 14 is mounted to pivotable arms 70 or some other retaining device which pivot at pivot points 74 and which are moved by the motor 42, gear 46, and gear elements 50, 54 to turn the pages.

It will be appreciated that the pages 18 may alternatively be turned by control levers which clip onto the pages of the book and which are selectively moved by one or more motors, or other page turning means known in the prior art. However, the present configuration is desirable because it minimizes the number of moving parts.

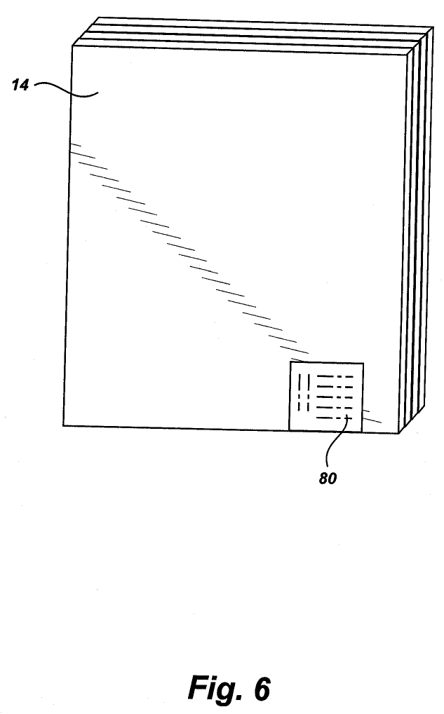

The book may have memory storage thereon as shown in FIG. 6, such as flash memory or some other circuitry attached to the book or partially embedded in a cover of the book. The memory may be connected to the mobile 10 when the book is attached to the mobile. Alternatively, memory may be provided separately and separately connected to the mobile as will be discussed.

The mobile 10 is thus optimized for books which have thick pages, such as infants books, as these pages will hold their shape. This allows the mobile to be placed above or adjacent the crib or chair of a child so as to be seen when the child is laying on their back, or to be placed at the side of a crib or chair with the book in an upright position.

Also shown in FIG. 1 is a mounting device 75. The mounting device 75 can be used for holding the device to a conventional arm of a mobile, for attachment of the device to the side of a crib, or for holding the device to some other structure, such as a car seat.

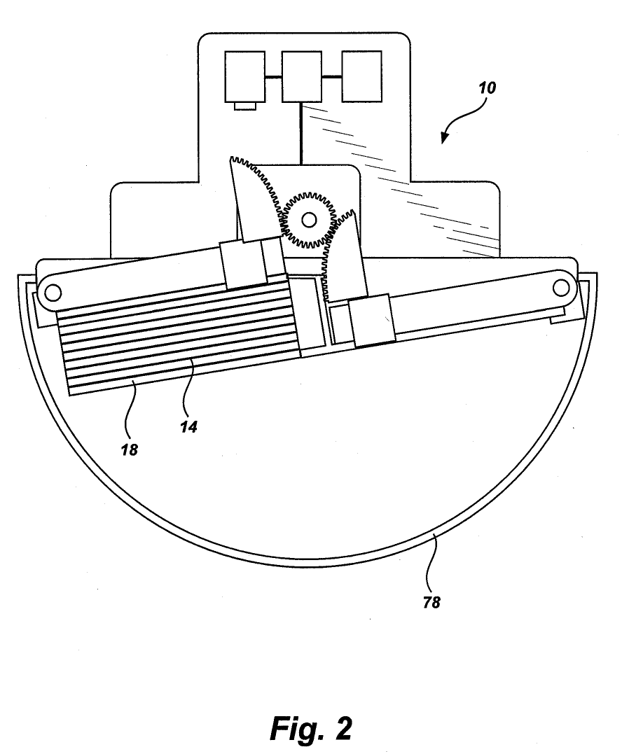

FIG. 2 illustrates how the mobile 10 typically includes a dome cover 78 which keeps the child from contacting the book 14 or the operational mechanism of the mobile 10. The cover 78 protects both the child and the mobile from harm or damage. The cover 78 is sized to allow the pages 18 to turn freely without contacting the cover. The cover is preferably a turn-lock cover wherein the cover can be attached by putting it in place and then rotating it a few degrees. This prevents the infant from removing the cover while making removal easy for an adult. Of course, other attachment mechanisms can also be used.

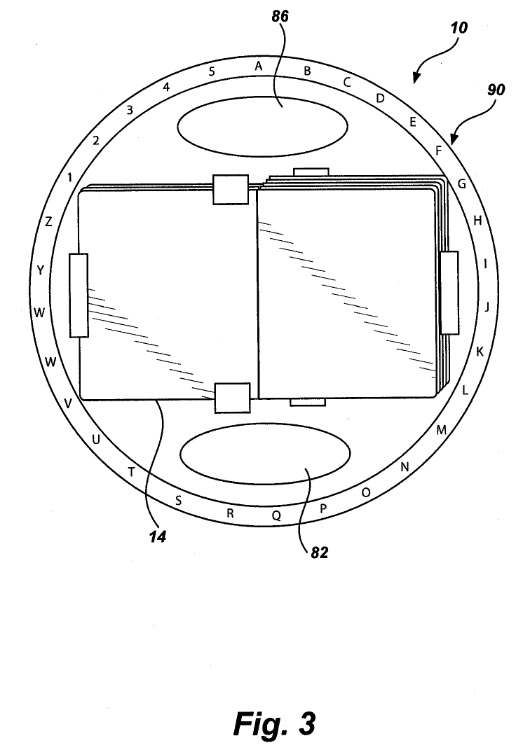

FIG. 3 shows a front view of the mobile 10, illustrating how the book 14 is easily viewed from the front of the mobile. The mobile will typically contain a speaker 82 which is used to present the audio recording to the child. Alternatively, the means for presenting an audio recording may be detached from the main body of the mobile such as a separate speaker system.

Additionally, the mobile may also contain a light 86. The light 86 may be used to illuminate the book 14 when the mobile is in use, allowing the room lights to be off. This may aid in drawing the child's attention to the book. The light 86 will typically be directed towards the book and not towards the child, and thus may utilize a guard to prevent the light from shining at the child. Additionally, the light may be mounted on a positionable arm, such as a flexible arm or an arm with joints therein, to allow the light to be properly aimed at the book. Such an arm may allow the light to be better positioned to illuminate the book 14. The light 86 may then be turned off after the book and audio recording are presented to the child to allow the child to sleep.

The light 86 may also function as a nightlight or to present lighting effects such as soft changing colors if desired. The mobile 10 may also include letters, numbers, etc. (as indicated at 90) which may be selectively illuminated as desired. The letters, numbers, etc. may be used as decoration, or may be used to teach the child in combination with books about letters, numbers, etc. The letters or numbers may have individual lights for illumination, or may be connected to a central light via fiber optics, etc.

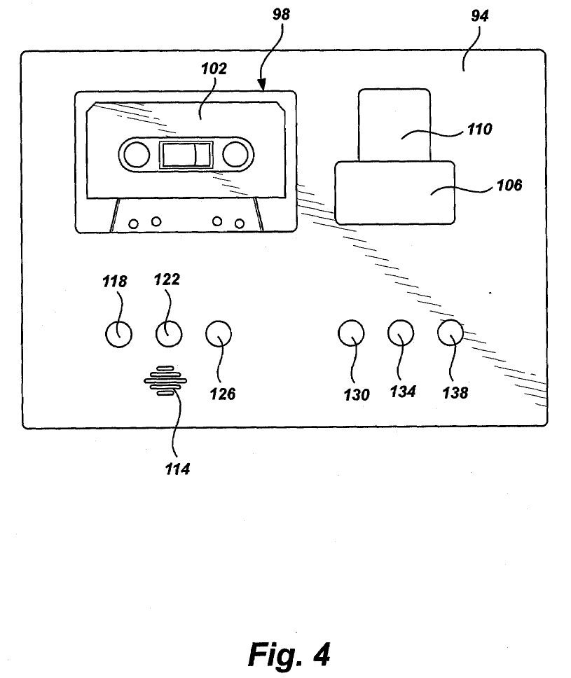

FIG. 4 shows a control panel 94 of the mobile 10. The control panel 94 may include a media reader 98, such as a tape reader, for reading a tape, CD, or other media which contains the audio recording corresponding to the book 14. The control panel 94 may also include a drive or port 106 for connecting flash media 110 or other media which contains the audio recording. A microphone 114 may be provided which allows a user to record the audio recording either to the tape 102 (or CD, etc.), flash media 110, or onboard memory 62. As such, the control panel 94 may include buttons such as a record bottom 118, a stop button 122, or a turn page button 126 which the user presses to indicate that it is time to turn the page. Pressing the turn page button 126 may place an indicator signal in the audio recording which signals to the computer controller 58 that it is time to turn the page of the book. The user may thus record their own voice telling the story of a book and play the same to a child. Such a configuration would allow any book to be used, and not just books produced with a specialized audio recording.

The control panel may have a play button 130, stop button 134, or mode button 138 to control the operation of the mobile 10. The mobile may thus be used to play the book and automatically turn off or revert to a nightlight or other mode afterwards, may be used to stop a book which is being played, may be placed into a music mode, nightlight mode, changing color mode, etc.

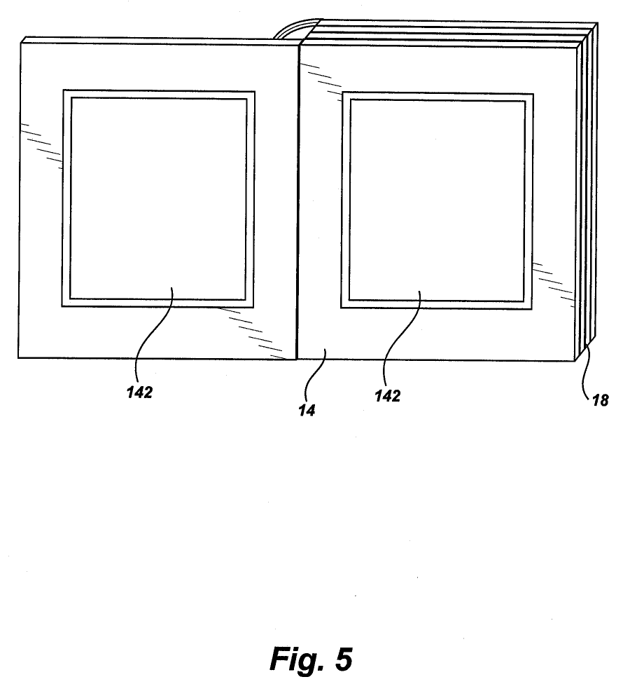

The mobile 10 may thus be used with different types of books. The books may be conventional children's story books. Alternatively, the books may be books which teach letters, numbers, shapes, language skills, foreign languages, etc. Many of such books may be used to educate a child. A photo album may also be used to familiarize a child with relatives. As shown in FIG. 5, a book 14 may be provided which has thick pages 18 and is sized for use with the mobile 10, and which has pockets 142 formed on the pages to allow a person to place photographs or the like therein to present the same to the child.

The mobile 10 allows a person to use commercially prepared books and audio recordings, and also allows a person to record a customized recording for a desired book. It is appreciated that the voice of a trusted parent may be more calming to a child than a strange voice. The media reader 98 or media drive/port 106 allow a user to record audio recordings on removable media and establish a library of books and recordings, rather than having to record the audio recording for each book every time the book is used. Thus, a person may simply buy a handful of flash memory cards or tapes and record audio tracks for a number of books and have these readily available.

The mobile of the present invention is desirable for parents of young children. A child may be entertained during waking hours, or the device may be used to help a child get back to sleep in the middle of the night when a parent may otherwise be too exhausted to stop and read a story to the child. The sound of the parent's voice is reassuring to the child and the parent is able to go back to sleep.

There is thus disclosed an improved children's book mobile/entertainment device. It will be appreciated that numerous changes may be made to the present invention without departing from the scope of the claims. The appended claims are intended to cover such modifications.

What is claimed is:

1. A children's mobile comprising:
a body;
one or more retention devices for attaching a book to the body and for holding a book in an open position so as to present the book to a child;
a drive mechanism configured for selectively turning the pages of the book; and
a control mechanism configured for selectively operating the drive mechanism so as to turn the pages of the book at a predetermined time.

2. The mobile of claim 1, further comprising a light for illuminating the book.

3. The mobile of claim 1, wherein the book is removably attached to the base.

4. The mobile of claim 1, further comprising a mounting device, whereby the mobile is removably attached to a structure such that the mobile is readily displayed to a child.

5. The mobile of claim 1, further comprising a cover for selectively limiting access to the book.

6. The mobile of claim 1, further comprising memory storage for storing an audio recording and comprising a playback device for playing the audio recording, and wherein the mobile plays the audio recording while the pages of the book are being presented to a child.

7. The mobile of claim 6, wherein the audio recording comprises a person reading the book.

8. The mobile of claim 6, further comprising recording means for allowing a person to record an audio recording and record the audio recording to the memory storage.

9. The mobile of claim 6, wherein the memory storage is removable from the mobile.

10. The mobile of claim 6, wherein the memory storage is located on the book.

11. A child's entertainment device comprising:
a mount mechanism for receiving a book;
a drive mechanism for turning the pages of the book; and
a control mechanism configured for selectively operating the drive mechanism.

12. The entertainment device of claim 11, wherein the book further comprises a photo album.

13. The entertainment device of claim 11, further comprising a light for illuminating the book.

14. The entertainment device of claim 11, wherein the mount mechanism comprises clamps which allow for the removable attachment of a book.

15. The entertainment device of claim 11, further comprising a mounting device, whereby the child's entertainment device is removably attached to a structure such that the mobile is readily displayed to a child.

16. The entertainment device of claim 11, further comprising a cover for selectively limiting access to the book.

17. The entertainment device of claim 11, further comprising memory storage for storing an audio recording and comprising a playback device for playing the audio recording, and wherein the mobile plays the audio recording while the pages of the book are being presented to a child.

18. The entertainment device of claim 17, wherein the audio recording comprises a person reading the book.

19. The entertainment device of claim 17, further comprising recording means for allowing a person to record an audio recording and record the audio recording to the memory storage.

20. The entertainment device of claim 17, wherein the memory storage is removable from the mobile.

21. The entertainment device of claim 17, wherein the memory storage is located on the book.
